(19) United States
(12) Patent Application Publication
(10) Pub. No.: US 2003/0182287 A1
(43) Pub. Date: Sep. 25, 2003

(54) Interface for an electronic spreadsheet and a database management system

(76) Inventor: Carlo Parlanti, Napoli (IT)

Correspondence Address: OBERMAYER REBMANN MAXWELL & HIPPEL LLP, 1617 JOHN F KENNEDY BLVD, 19TH FLOOR, PHILIDELPHIA, PA, 19103, US

(21) Appl. No.: 10/105,033

(22) Filed: Mar. 22, 2002

(51) Int. Cl. G06F 17/30; G06F 17/00

(52) U.S. Cl. 707/10; 707/102

(57) ABSTRACT

A generalized system between a first user system and any universal data access provider or open database connectivity data source for database management systems comprising: means for affixing to a first program instructions from a generalized interface between a first application and any UDA (Universal Data Access) provider or ODBC (Open Database Connectivity) data source for a DBMS (Database Management Systems); and means to affix instructions on the first application such that a sequence of statements to be performed for each Command can be embedded via the DBMS into the database. 12

### FIELD OF THE INVENTION

The present invention is directed to software interfaces. In particular, the present invention is directed to a generalized interface for an Electronic Spreadsheet program, such as Microsoft Excel, and any data provider supported from Microsoft Universal Data Access (UDA), such as an Open Database Connectivity driver (ODBC), for a Database Management System (DBMS) such as DB2/400.

### BACKGROUND OF THE INVENTION

Many of today's application programs utilize the Microsoft Data Access Components (MDAC) interface to access data in Database Management Systems (DBMSs) using Structured Query Language (SQL) syntax. The MDAC interface provides interoperability, such that a single application program can access data from many different DBMSs. This interoperability allows an application developer to develop, compile, and ship an application program without targeting a specific DBMS.

Typically, when a user then buys the application program, the user can add modules, known as data providers or database drivers, which link the application program to the user's choice of DBMSs. The UDA interface is more clearly described in the Microsoft Universal Data Access documentation at http://www.microsoft.com/data/. The ODBC interface is more clearly described in ODBC 2.0 Programmer's Reference and SDK Guide, Microsoft Press (1994), at pages 3-15, 23-87, and 181-519.

When accessing a DBMS using an MDAC interface, an application program utilizes various functions of the interface to issue commands containing SQL statements to the database driver, which then sends the SQL statements to the DBMS. After receiving the SQL statements, the DBMS processes them and, eventually, returns information back to the application program.

Although the MDAC interface provides interoperability many existing DBMSs (known as legacy DBMSs) either do not have an ODBC database driver for use with an ODBC-compliant application program or do not allow access from entities other than a single application program that acts as the legacy DBMS's only client. In both of these situations, an ODBC-compliant application program cannot access the data contained in the legacy DBMS. Because there are many legacy DBMSs, this limitation is significant, as the limitation renders the data in these legacy DBMSs inaccessible. It is therefore desirable to integrate legacy DBMSs with application programs that utilize the ODBC interface.

U.S. Pat. No. 6,052,285, assigned to Mosaics, Inc., for example, is directed to a database integrator to an application program that utilizes the OBDC interface so as to enable an application program to access the data in legacy DBMS. The application program (the client program) is located on a workstation, and legacy DBMS is located on a host computer. The legacy DBMS is used primarily by an application program “the server program”. The database integrator receives ODBC commands from the client program, and unlike database drivers interacting with non-legacy DBMSs that send SQL statements to the DBMS, the database integrator instead converts these commands into server program-specific commands to manipulate the user interface of the server program, establishes a connection with the server program for a terminal emulation session, and issues the server program, specific commands to the server program by using the terminal emulator. These server program-specific commands manipulate the server programs user interface to display appropriate data so that the database integrator can then access it. In this manner, the database integrator accesses the data in the legacy DBMS indirectly by issuing user interface commands to the server program, because the database integrator cannot typically access the legacy DBMS directly. This indirect access enables the client program to gain access to the data in a database that would not otherwise be able to access. While the '285 patent is applicable to a number of database applications, it is not related in any way to electronic spreadsheet applications such as Microsoft Excel.

Microsoft Excel is one of the most popular spreadsheet computer applications, which is used by business through out the world. Excel provides a number of business and related applications. Excel pages come in a workbook format. Heretofore, there has not been an easy system for easily interfacing between a personal computer based electronic spreadsheet such as Excel or Lotus 123 and an MDAC data provider or ODBC data source for database management systems, including but not limited to DB2/400.

Heretofore, it has been necessary to engage in extensive programming to create such a specialized application. Frequently, businesses have numerous items, vendors, accounting instructions, and other data elements that need to be loaded into a computer system before the “go live” date. Often the solution is to hire temporary help to manually input all of the information into the new system, screen after screen. Alternatively, the entity may be forced to use valuable programming resources to develop “quick and dirty” programs to populate the Data Base Management System from a Legacy System database. On one hand, the enterprise is handing out data to temporary help that are unfamiliar with its data or Conference Room Pilot strategy. On the other hand, this may jeopardize the entity's implementation by counting on Information Technology resources availability or on costly consultants. No matter what, the “go live” date and the quality of the implementation are at risk.

It is therefore a principal object of the present invention to provide a system that interfaces between an Electronic Spreadsheet and an UDA data provider for a Database Management System.

It is still a further object of the present invention to provide a system that interfaces between an end user spreadsheet program and an ODBC data source for a database management system.

It is still a further object of the present invention to provide a system that interfaces between an end user program such as Microsoft Excel or Lotus 123 and an MDAC data provider for a database management system.

It is still a further object of the present invention to provide a system that interfaces between a program such as Microsoft Excel and an ODBC data source for a database management system such as DB2/400.

It is still a further obligation of the present invention to provide a system which creates an MDAC or OBDC interface between Electronic Spreadsheets, such as Excel, and DBMS, such as DB2/400, without the need for extensive programming.

These and other objects of the present invention will become clear from the attached summary and detailed description, which follow.

### SUMMARY OF THE INVENTION

The present invention is directed to a generalized interface system between a first database system and any open database connectivity data source for database management systems. In the preferred embodiment, the invention provides a system for embedding comments and instructions and embedding them into the DBMS. In a more preferred embodiment, the present invention provides a generalized interface between Microsoft Excel 97, 2000 and 2002 and any UDA (Universal Data Access) data provider or ODBC (Open Database Connectivity) data source for DBMS (Database Management Systems). The interface reads a profile file (.ini) and interprets the instructions in this file to add commands to the Excel Menu bar. This profile file also contains instructions on the sequence of SQL statements to be performed for each Command added and embedded these in the SQL database.

The two main critical features of the interface of the present invention interface are its ability to retrieve values from the workbook itself, embedding these values inside statements coupled with the ability to perform any SQL statement (according to the level of the UDA, ODBC and DBMS driver in use). In a most preferred embodiment, the interface of the present invention has been developed using Microsoft Visual Basic Application Edition and uses the Microsoft Data Access Components MDAC 2.5 SP2 Library (C:\Program Files\Common Files\System\ADO\msado15.dll) for data access.

In the most preferred embodiment, the minimal requirements to use the interface are Microsoft Windows 98, NT, 2000 or XP and Microsoft Excel 97, 2000 or 2002.

The present interface is a generalized interface between a program such as Microsoft Excel 97, 2000, 2002 and any UDA (Universal Data Access) data provider or ODBC (Open Database Connectivity) data source for DBMS (Database Management Systems). The interface of the present invention reads a simple script that enables the user to add commands to the Excel Menu bar. For each of these commands, the user can specify multiple activities to perform against databases in multiple data sources. The user can retrieve, upload, update and delete information between more than one DBMS using an interface such as a GVI.

The scripting language is simple and permits a novice user of the invention to quickly prepare one maintenance model for a master table. Users can also use advanced features to push the usage of the interface to limits previously only reached with complex and expensive Visual Basic development. Features of the invention include an integrated debugger, conditional logic, nested SQL statements, multi-sources and multi-steps command, complete two-way integration with Excel macros and many more.

The interface provides the user with the ability to map in one embodiment, Excel cells or columns to data elements in an ERP system. It then allows the user to retrieve values from an Excel workbook and embed them inside SQL statements. The user can perform virtually any type of database activity including running stored procedures and submitting remote jobs (according to the DBMS, UDA and ODBC driver in use).

The invention in one embodiment has been developed using Microsoft Visual Basic Application Edition and uses the Microsoft Data Access Components MDAC 2.5 SP2 Library (C:\Program Files\Common Files\System\ADO\msado15.dll. The minimal requirements to use this invention are Microsoft Windows 98, NT, 2000 or XP and Microsoft Excel 97, 2000 or 2002.

In accordance with the present invention, a generalized system between a first user system and any open database connectivity data source for database management systems comprising: means for affixing to a first program instructions from a generalized interface between a first application and any UDA (Universal Data Access) data provider or ODBC (Open Database Connectivity) data source for a DBMS (Database Management Systems); means to affix instructions on the first application such that a sequence of statements to be performed for each Command can be embedded via the DBMS into the database.

In a further embodiment, the invention is a method for operating a generalized interface between an electronic spreadsheet program such as Microsoft Excel and an ODBC datasource for a DBMS comprising the following steps: retrieving a value from a first end user application having a graphical interface field and replacing the corresponding field in the first application with at least one command or comment relevant to a DBMS statement; and affixing the command or comment inside said DBMS statement and storing said command or comment within a database associated with said DBMS.

In a still further embodiment, the invention is a generalized system between a first user system comprising a workbook and any open database connectivity data source for database management systems comprising: means for affixing to the interface of first workbook program instructions from a generalized interface between said first application and any ODBC (Open Database Connectivity) data source for a DBMS (Database Management Systems); and means to embed commands from said first workbook application via the DBMS into the database.

The invention comprises a novel interface between a first workbook application having a menu interface and any ODBC wherein said interface reads a script and enables a user to add commands to the menu interface of the workbook application.

These and other objects of the invention are described below in the following detailed description.

### BRIEF DESCRIPTION OF THE FIGURES

FIGS. 1a and 1b illustrate user screens of the operation of the present invention.

FIGS. 2a to 2b illustrate a more preferred embodiment of the present invention is shown and described.

FIG. 3 illustrates an ODBC data source for the Microsoft Northwind database.

FIGS. 4a to 4c illustrate the operation of an Access driver to will prompt a Select Database dialog within the system.

FIGS. 5a and 5b illustrate the use of the Excel program to open the sample customer management workbook for the Northwind database.

FIG. 6 illustrates the clicking on the Menu Northwind to select Retrieve Customers.

FIGS. 7a and 7b illustrate the splash screen of the present invention.

FIG. 8 illustrates the use of profile files by the interface.

FIG. 9 shows the first Main section in a profile file.

FIG. 10 shows that the profile file can contain as many commands as desired.

FIG. 11 illustrates the Key Menu command.

FIGS. 12a to 12f illustrate the steps for setting up the invention.

FIGS. 13a to 13d illustrate the steps for debugging the invention.

FIGS. 14a and 14b relate to the application of the present invention to Visual Basic.

FIG. 15 sets forth a complete customer management application.

FIGS. 16a and 16b illustrate how the Retrieve Customers Command retrieves the list of customers available for the country specified in the tab Select and Update.

FIGS. 17a and 17b illustrate how the Update Customers Command updates the customers in the database with the values specified in the tab Select and Update tab.

FIGS. 18a and 18b illustrate how the Insert Customer Command adds a new customer in the database with the values specified in the tab Insert and Delete.

FIGS. 19a and 19b illustrate how the Delete Customer Command removes the customer specified in the tab Insert and Delete from the database.

FIGS. 20a to 20f illustrate the use of the in the context of a further example including an Expense Report.

FIGS. 21a-21d illustrate how the Process Expense Reports Command submits the Batch Voucher or Invoice Processing program in the J. D. Edwards® system as shown.

FIGS. 22a to 22b, illustrate the use of an automated expense report with online prompting for cost centers, expense categories, special projects or subledgers, and vendors.

FIG. 23a is an automated interface to maintain items in the J. D. Edwards® Inventory.

As shown in FIGS. 24a to 24d, the workbook is an automated item maintenance tool with dynamic selection of items.

FIG. 25 illustrates how after downloading the items, it is possible for the user to assign them an UNSPSC class.

### DETAILED DESCRIPTION OF THE PREFERRED EMBODIMENT

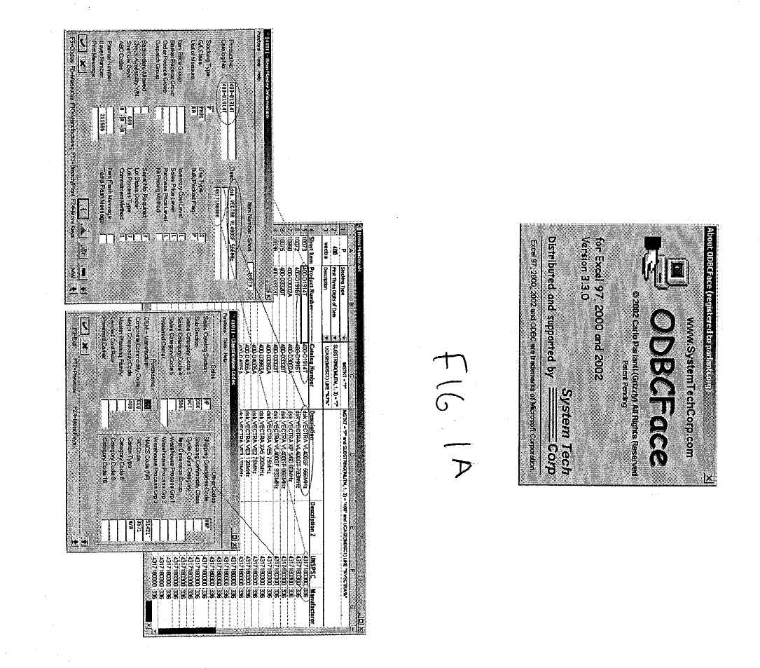

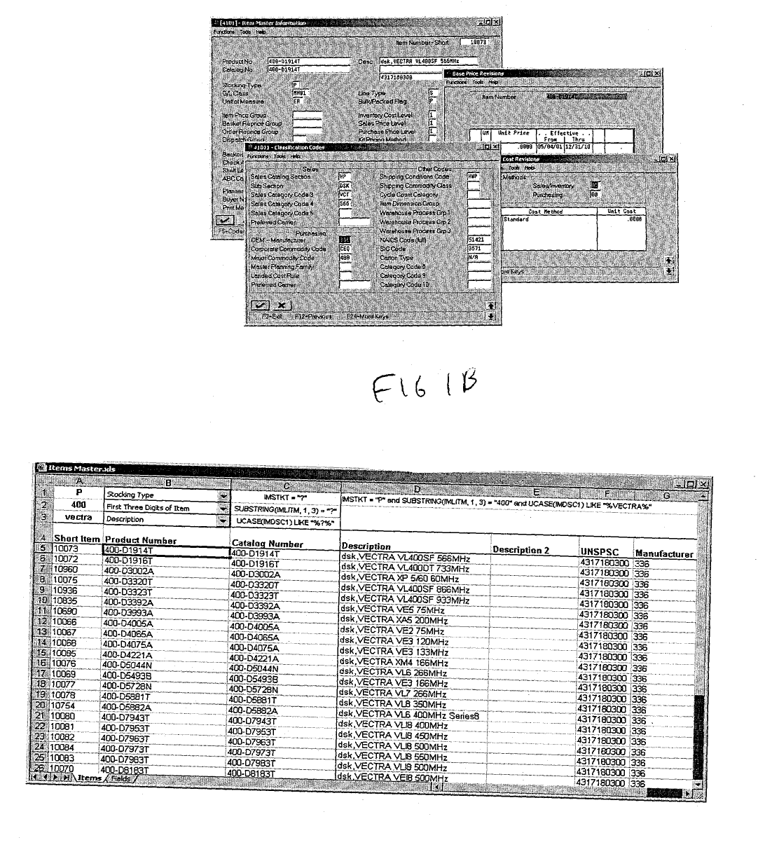

The present invention is described with reference to the enclosed Figures wherein the same numbers are used, where applicable as shown in FIGS. 1A and 1B. In the most preferred embodiment, the present invention is directed to a system in which the Figures is a flowchart of the invention. As shown, the invention comprises a system 10 which is loaded via the menu of a spreadsheet application 12 such as Excel or Lotus 123 14. The system then uses an interface “to create tags”, which are then stored in the second data system . In a most preferred embodiment, the invention is directed to a system wherein comments and notes 16 can be embedded in a relational database from a user application. While the present invention in a most preferred embodiment is described in the context of Microsoft Excel it is to be appreciated that the present invention is applicable to other software applications.

The particular problem which the invention seeks to address numerous entities that face numerous items, vendors, accounting instructions, and other data elements that need to be loaded into a system before a “go live” date. It is often necessary for a company to hire temporary help to manually input all of the information into the new system, screen after screen. Alternatively, the firm can use programming resources to develop “quick and dirty programs” to populate your Data Base Management System from a Legacy System database. This creates problems. The firm is handing out data to temporary help that is unfamiliar with the company data or your Conference Room Pilot strategy. On the other hand, they may jeopardize their implementation by counting on Information Technology resources availability or on costly consultants. No matter what, the “go live” date and the quality of implementation are at risk. The real shame is that their super users have already prepared and organized all the information in the tool that they feel most comfortable with: Excel. If only there was a way to transfer all that information into their ERP at the touch of a magic wand . . .

The present invention provides a generalized interface between Microsoft Excel 97, 2000, 2002 and any UDA (Universal Data Access) data provider or ODBC (Open Database Connectivity)data source for DBMS (Database Management Systems). The interface reads a simple script that enables the user to add commands to an Excel Menu bar. For each of these commands, the user can specify multiple activities to perform against databases in multiple data sources. The user can retrieve, upload, update and delete information between more than one DBMS at the touch of a magic wand or, better, at the click of a mouse.

The scripting language, used with the invention is so simple that a novice user of invention can prepare one maintenance model for a master table in a couple of hours. They can also use advanced features to push the usage of the invention to limits previously only reached with complex and expensive Visual Basic development.

As shown in FIG. 1B, the features of the invention include an integrated debugger, conditional logic, nested SQL statements, multi-sources and multi-steps command, complete two-way integration with Excel macros and many more. The invention provides the user with the ability to map Excel cells or columns to data elements in your ERP system. The invention also lets you retrieve values from an Excel workbook and embed them inside SQL statements. The user can perform virtually any type of database activity including running stored procedures and submitting remote jobs (according to the DBMS, UDA and ODBC driver in use).

In one embodiment, the invention has been developed using Microsoft Visual Basic Application Edition and uses the Microsoft Data Access Components MDAC 2.5 SP2 Library (C:\Program Files\Common Files\System\ADO\msado15.dll. The minimal requirements to use this interface are Microsoft Windows 98, NT, 2000 or XP and Microsoft Excel 97, 2000 or 2002.

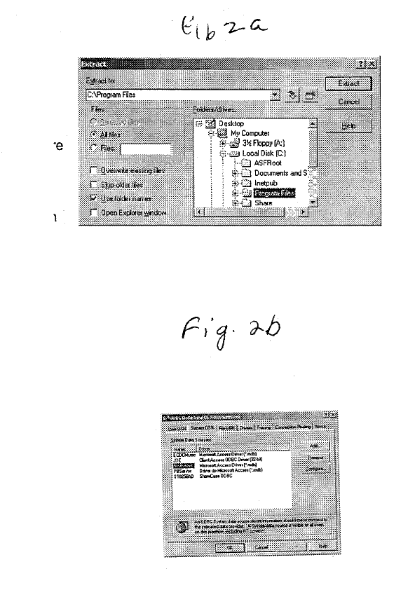

Referring now to FIGS. 2a to 2b, a most preferred embodiment of the present invention is shown and described. In a most preferred embodiment of the present invention, a Program Files folder is created. This contains the interface add-in, the documentation in Acrobat Reader format and four subfolders. The first add-on, IBM Library Reader Extract, contains an IBM sample for an ODBC security exit program. The second, Microsoft Data Access Components MDAC 2.5 SP2, contain Microsoft components that may be needed to install for the present invention to work properly, the third, Samples, contains samples workbooks and profiles.

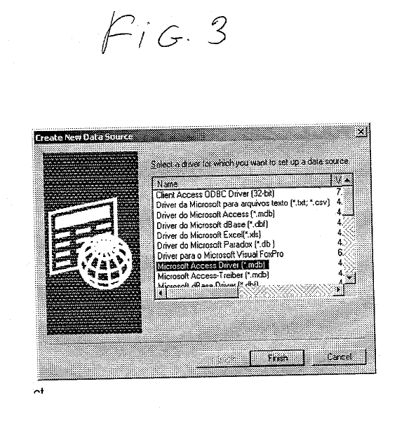

In order to test the simplest sample workbooks, an ODBC data source for the Microsoft Northwind database is depicted in FIG. 3. Northwind is a sample Access database which is shipped with the Microsoft Office suite. When prompted the Microsoft Access Driver (*.mdb) should be selected. As shown, the user should assign the name Northwind in the text box Data Source Name and use description Microsoft Northwind in the text box Description. Click on the button Select in the frame Database.

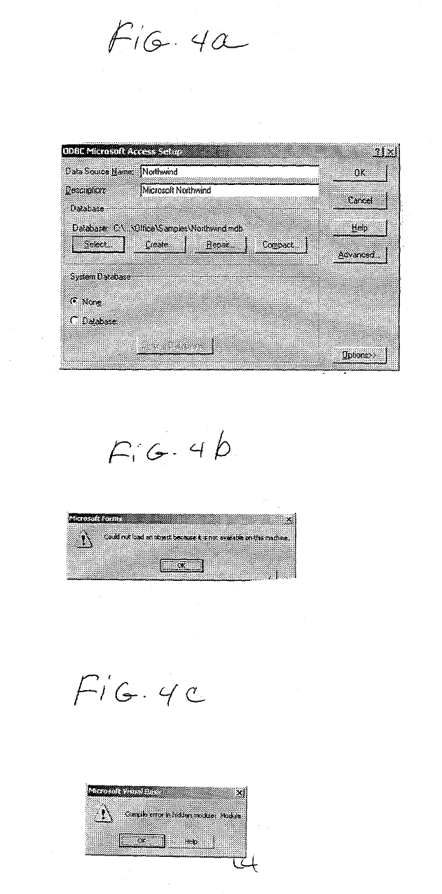

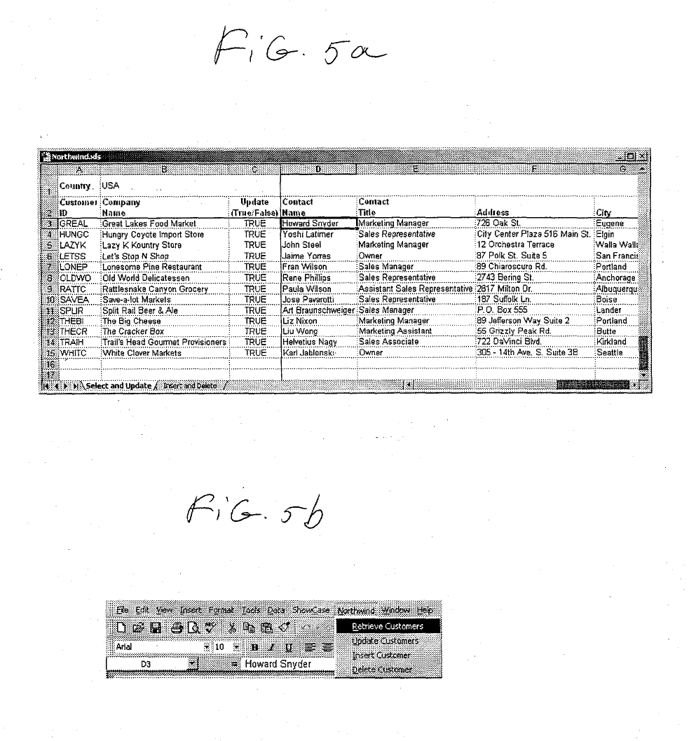

As shown in FIGS. 4a to 4c, in operation, the Access driver will prompt a Select Database dialog within the system. The sample folder of Microsoft Office will then be browsed, usually C:\Program Files\Microsoft Office\Office\Samples, and the database Northwind.mdb is preferably selected. The user will then click on the OK button to accept the selection. By clicking again on the OK button, in the ODBC Microsoft Access Setup form the user will complete the definition. The user will click OK on the ODBC Data Source Administrator form to close it. You are now ready to try ODBCFace. Browse, using Windows Explorer, to the folder C:\Program Files\ODBCFace\Samples and double click on the Excel workbook Northwind.xls.

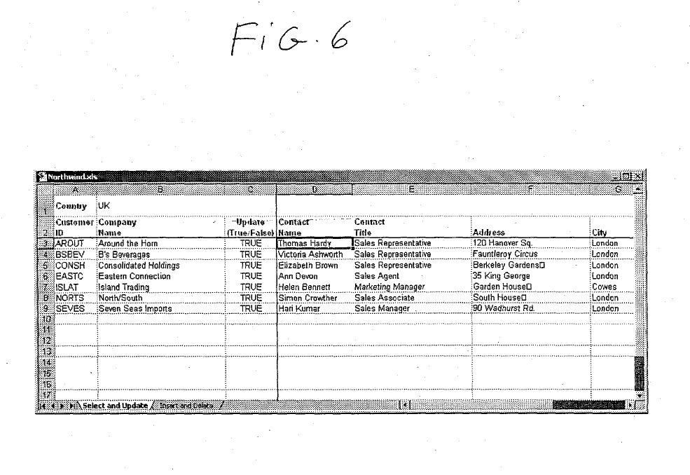

As shown in FIGS. 5a and 5b, the Excel program will open the sample customer management workbook for the Northwind database. Immediately after opening the workbook, the system interface add-in will be loaded, and the user will see the splash screen of the application. The workbook contains two sheets. The first, Select and Update is designed to retrieve customers from the Northwind database and update their information. The second, Insert and Delete is designed to add new customers and delete existing ones.

As seen in FIG. 5a, a critical feature of the invention is that a new Menu is added in the Excel Menu bar. The name of the Menu may be provided and can be activated with the shortcut Alt+n. The new Menu contains four commands; retrieve, update, add and delete customers in the Northwind sample database.

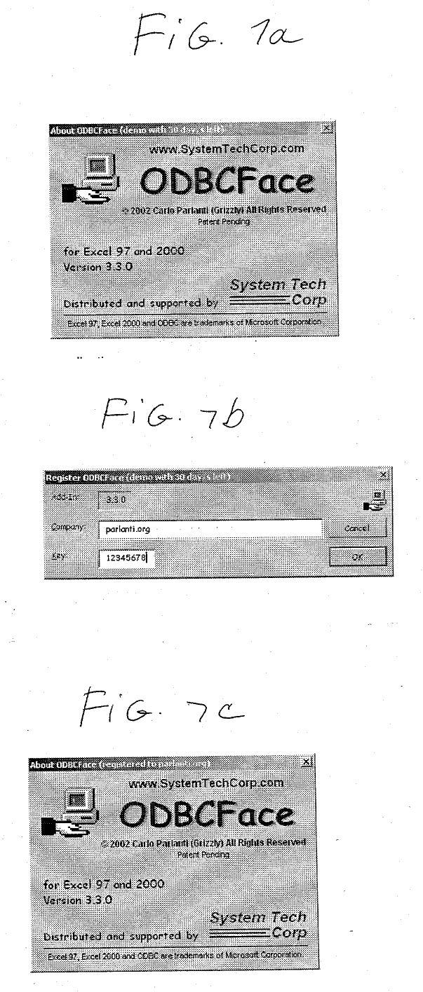

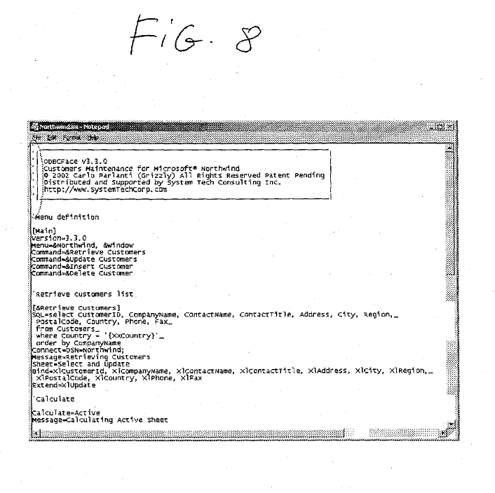

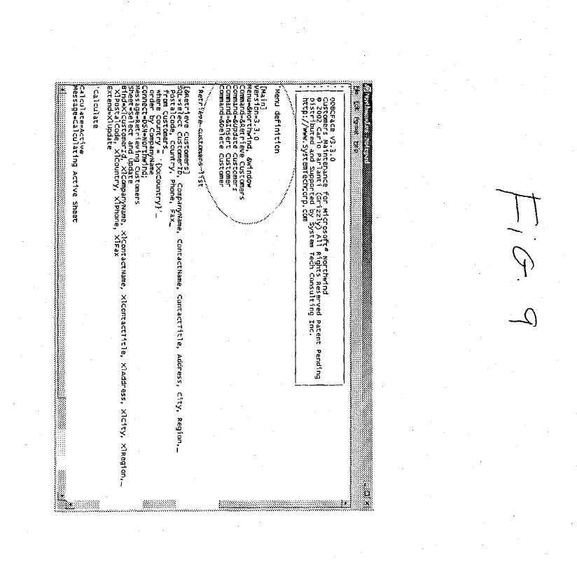

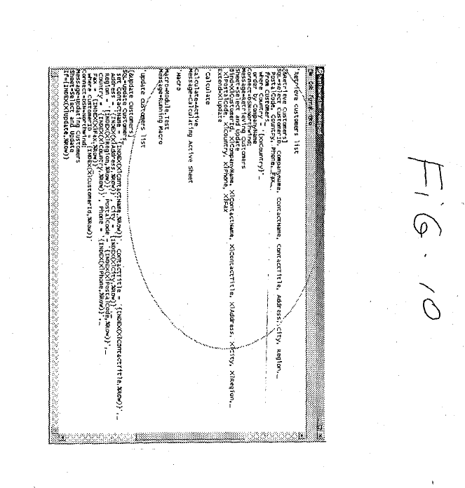

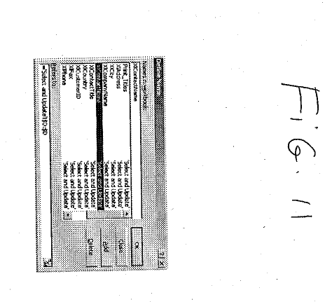

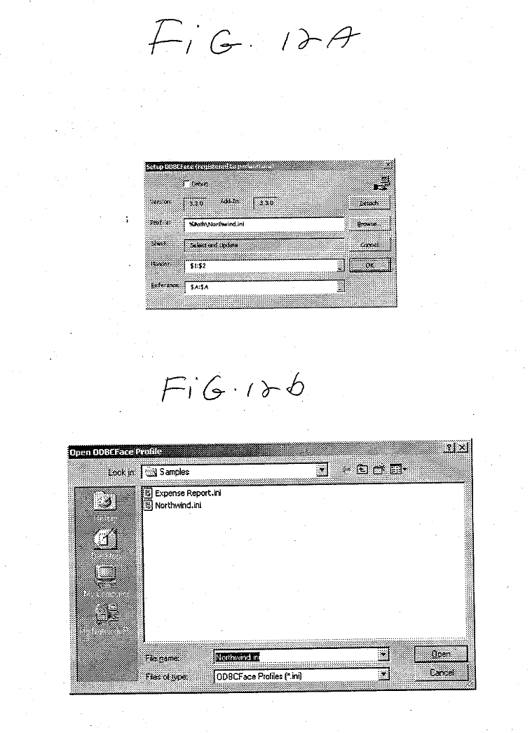

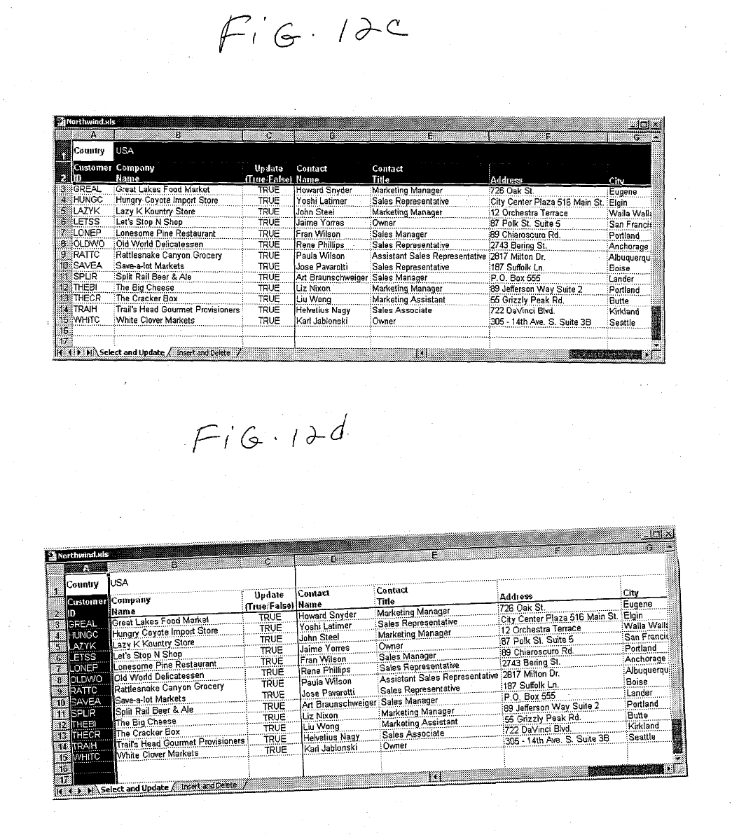

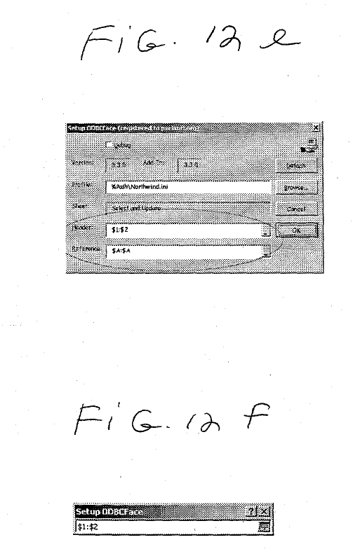

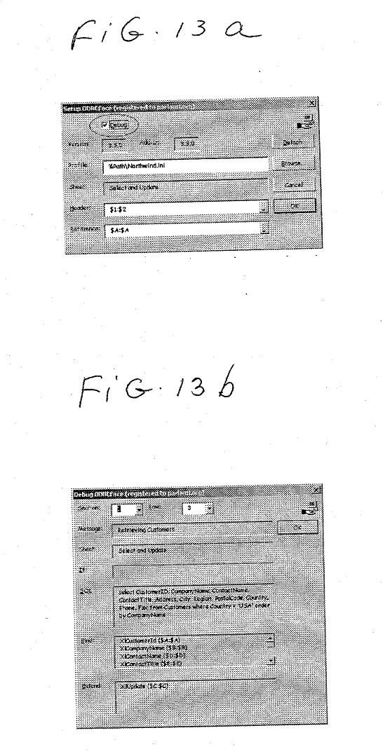

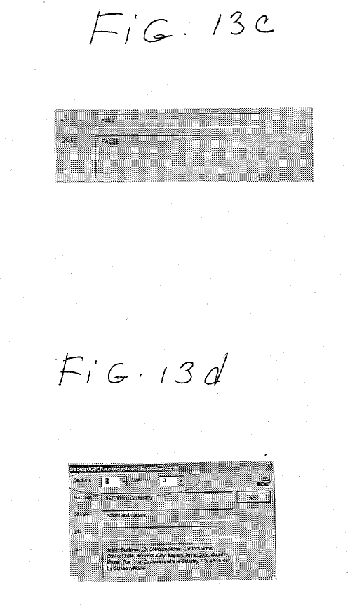

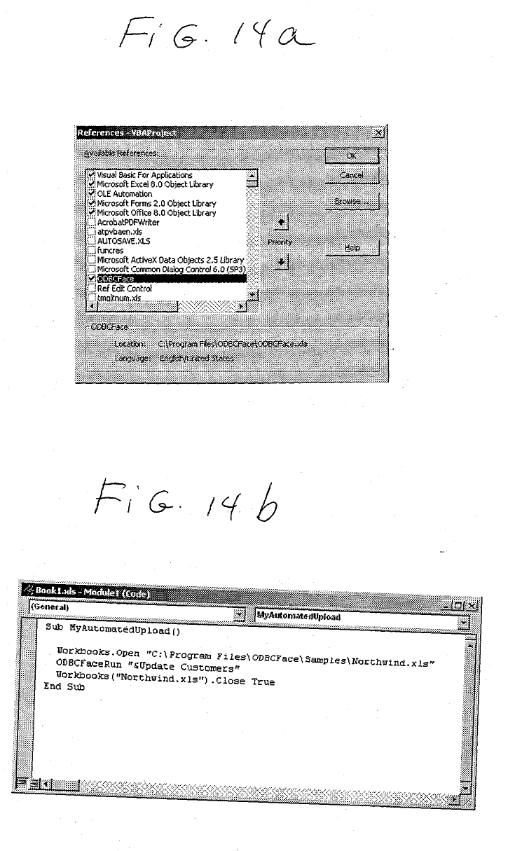

Initially the user will click on the cell Country (cell B1) and change the value from USA to UK. As shown in FIG. 6, the user would click on the Menu Northwind and select Retrieve Customers. The user will see a message box with the text; a test Macro. The user will click on the OK button. The workbook will now list all the customers from the United Kingdom as shown in FIG. 6.

Referring now to FIGS. 7a and 7b, the first time the invention is opened, a splash screen is displayed. The syntax that is required to write a profile file and the techniques to instruct the novel interface to use this profile file are now described.

Profile Syntax

As shown in FIG. 8, the interface is based on profile files with an extension .ini. The profile has a strict syntax that needs to be respected. The complete description of the syntax is explained below.

Comments

The comment profile permits the user to insert comment lines where needed to the document the file itself. To write a comment, the user will type a single apostrophe (‘) at the very beginning of the line. The single quote must be at the very beginning of the line and no comments are allowed after normal instructions on the same line. An empty line is also considered a comment.

Section [Main]

As shown in FIG. 9, the first section in a profile file must be called Main. The profile's main section is recognized by the line [Main] at the very beginning of the section itself. It contains the Menu and commands to be added to a Menu bar.

Key Version

The Key Version is recognized by the characters “Version=” at the beginning of the line. This instructs the program to perform a version check between the profile and the add-in and, if they don't match, display a warning message for the user.

Key Menu

The Key Menu is recognized by the characters “Menu=” at the beginning of the line. This instructs the program that the user wants to add a Menu in the Excel Menu bar. The “&” character tells Excel which is the shortcut key that will be used to activate the Menu. The user can specify, after a single comma, the name of the Menu before which the user wants to add the new Menu. If the user does not specify any, the new Menu will be added at the end of the Menu bar.

Key Command

The Key Command is recognized by the characters “Command=” at the beginning of the line. This informs the program that the user wants to add a Command in the Excel Menu bar. The main section can contain as many Command keys as desired. The “&” character tells Excel which is the shortcut key that will be used to activate the interface using that section.

Section [Command]

As shown in FIG. 10, the profile file can contain as many commands as desired. Each one must contain a section with the same name of the Command key in the main section. It is noted that the shortcut key (&) must be included in the section name. Every Command can include a multiple section. Each section must start with the keywords Calculate, Macro or SQL.

In this manner, for example, the user can retrieve data from one data source. It is possible to retrieve more data from a second data source and then recalculate the formulas in the workbook. The results of the workbook are then uploaded. The results of the formula in a third data source are also uploaded and, finally, run some kind of Macro to format and print the result of the interface.

Key Calculate

The Key Calculate is recognized by the characters “Calculate=” at the beginning of a line. In order to speed up the execution of the interface, the invention turns the calculation mode to “manual” before any activity. The calculation is then reset to the previous mode after the interface has been performed. The feature controls the recalculation of all the open workbooks (or of the active Sheet) during the execution of different steps of the interface.

Value are active meaning all the open work books are recalculated. Only the active sheet is recalculated.

Key Macro

The Key Macro is recognized by the characters “Macro=” at the beginning of the line. This key instructs ODBCFace to run a Macro in the current workbook. If the Macro is in a different workbook or add-in you can also prefix the name of the Macro with the workbook name.

Key Message

The key Message is recognized by the characters “Message=” at the beginning of the line. This is the message that will be displayed from the interface in the status bar of Excel. The system will append to the message additional information to keep the user updated on the activity of the interface.

Key SQL Statement

The key SQL Statement is recognized by the characters “SQL=” at the beginning of a line. The SQL statement can comprise any statement recognized from the data source in use. This statement can include values retrieved from the Excel workbook. Whenever a field included in the statement references a column in the Excel workbook, the statement is treated as a recurring statement and executed multiple times (once for every element in the Excel column).

The statement can be checked before being actually executed by using the debug mode. Because the SQL statement can be very long, it can be extended to a new line of the profile file using the underscore character (_) at the very end of the line.

Field Syntax

Referring to FIG. 11, the present invention can retrieve values, for example, from the Excel workbook. It is to be noted that there is a special syntax to be used to retrieve values from the workbook. A field to be retrieved from the Excel workbook needs to be enclosed between the character “{” and the character “}”. Between the field separators (“{” and “}”) any valid Excel formula removing the “=” symbol can be specified required from Excel to distinguish a formula from a value.

Inside the formula, it is recommended that names cells or columns be utilized instead of explicit references (simple like A2 or $A$2 or qualified like Sheet!$A$2). In this manner, the reference it's going to be valid also if the user moves the column or cell in a different position in the model. If a reference is required to be treated as a column inside a repetitive interface you can embed inside the formula the special code “% Row” that is going to be replaced from novel interface the current row number during the execution of the statement. It is critical to pay particular attention to the fact that the special code “% Row” is case sensitive (“%ROW”is not going to work).

The present invention provides for a multiplicity in the complexity of the formulas that can be described. It is suggested that the formulas be tested within the Excel workbook before attempting to write them in the profile file. Formulas such as TEXT to format numbers can be used as well as; LEFT or RIGHT or MID to resize a field; LEN to evaluate lengths; and REPT to perform filling and any other valid Excel formulas including any custom function written from you or a third party in Visual Basic Application edition.

Because Excel copies a local version of the value of remote references to other workbooks, the present invention cannot refer to other workbooks within a formula (in a lookup or any other formulas). You can refer to other sheets but only within the same workbook.

Key Connect

Key Connect is recognized by the characters “Connect=” at the beginning of the line. The connection string follows the standard syntax for ODBC connectivity and can contain simply the data source name or any other ODBC driver specific information. Please consult the on line help for the ODBC driver to verify the specific syntax required. For example, it is possible to provide the driver with the user name and the password for the connection. It is not necessary to repeat a connection string if the previous section of the same Command has already specified a valid one.

Key Sheet

The key Sheet is recognized by the characters “Sheet=” at the beginning of the line. It provides the ability to specify a default Sheet for the references used in the SQL statement, Bind and Extend Lists. You can still override one specific field by simply prefixing it with the name of the Sheet you want to retrieve it from (‘Sheet’!AmountJDE).

Key Bind List

The key Bind List is recognized by the characters “Bind=” at the beginning of the line. The binding list must be used every time the statement is supposed to retrieve results. It must contain the list of columns where you want to import the values from the database separated with comas (,). Inside the binding list it is recommended to use named cells or columns instead of explicit references (simple like A2 or $A$2 or qualified like Sheet!$A$2). This way the binding list it's going to be valid also if the user moves the column or cell in a different position in the model. Because the binding list can be very long it can be extended to a new line of the profile file using the underscore character (_) at the very end of the line.

Key Extend List

The key Extend List is recognized by the characters “Extend=” at the beginning of the line. The extending list must be used every time you have a column in a workbook that contains a formula and it is desirable to extend or reduce that column together with the columns imported from the database. The syntax for the Extend list is the same as for the Key Bind List.

Key If Condition

The Key If Condition is recognized by the characters “If=” at the beginning of the line. Sometimes you do not want to upload (insert statement), update (update statement) or delete (delete statement) all the rows contained in your workbook. You can use the key If to select which row you want to upload, update or delete. The If statement is evaluated in the same manner Excel evaluates and=IF( ) formula and the statement is executed only if the value of the If line is equal to true. Within the key If you can use any reference to the Excel model following the same syntax utilized in the section Field Syntax. The interface substitutes all the fields in the If line, then embeds the line in an Excel=IF( ) formula and evaluates it to retrieve a true or false value.

Setting Up the Invention

Referring to FIGS. 12a to 12f, after writing the profile file (*.ini), the invention, as an add-in program, is attached to the Excel model. In order to accomplish this, it is necessary to open the add-in program as an xla file open the Excel model (Northwind.xls in this sample) and press the shortcut Ctrl+Alt+O. The start up form for the invention is then be displayed. It is possible to use the Excel Add-ins Manager to automatically forward the .xla each time Excel (Tools, Add-Ins . . . ) is launched. The first button, on the right top corner of the form, indicates if the workbook is already attached to the program or not. With this button, it is possible to detach a model from the program or attach a new model. Immediately below, the Profile text box shows which profile file is going to be read and interpreted from the interface.

To change the value on the second button, that button is clicked, so as to display a dialog box that permits the user to pick the profile file that he wants to associate to this model. In the Profile text box a qualified file name can be used, a simple one (retrieved from the current folder) or the special keyword % Path can be hit to represent the same folder of the Excel model.

The last three text boxes (Sheet, Header and Reference) provide the user with the capability to indicate to the interface what is the extent of the header area in the Sheet (if any) and what column should be considered as the reference for repetitive SQL instructions. For example, the Sheet Select and Update of the workbook (e.g., Northwind.xls, has a header area composed from the first two rows of the Sheet. Any download or update operation will ignore the defined header area. In this example, the header area is defined as the first two rows ($1:$2).

Also, the column $A:$A should be considered the reference point to understand when it is necessary to stop updating information. To specify a header area and a reference column for a Sheet, the user can select the Sheet. Before the user runs the Setup of the invention, press Ctrl+Alt+O which indicates the area and column in the text box Header.

In the Header or Reference text box, the user then selects the rows for the header area and the column for the reference with his mouse (these text boxes are special reference text boxes). It is also possible to click on the dots on the right side of the text box Header or Reference. It may be necessary to reduce the dimension of the form to only the text box giving you more room to select the header area or the reference column. After selecting the area or the column, the user can click on the icon on the right side of the text box to display the form in its original format and click OK to confirm the assignment. It is important make sure to select entire rows starting with row 1 for the header area and to select only one entire column for the reference column.

Debugging the Present Invention

Referring to FIGS. 13a to 13d, after attaching the add-in program to the model it is necessary to debug the script to confirm that the proper SQL statements have been used and to retrieve the proper information from Excel. In order to troubleshoot, the invention, in one embodiment, is provided with a debug tool. To activate the debug tool in one embodiment, the user will press the shortcut Ctrl+Alt+O to open a form Setup. The user will then check the Debug box, click OK to confirm and choose the Command Retrieve Customers from the Menu for Northwind. The present invention reads the profile, interprets it and, instead of running the SQL instructions against the ODBC driver displays a debug form. The debug form displays for the individual sections of the Command you are testing (and the individual rows if the section is a repetitive one). The user then can toggle from one section to the following by using the drop down list Section and from one row to the next by using the drop down list Row.

The first text box provides the message to be used as a prefix for status message during the execution of the section of the Command. The default sheet for the section is showing or the current sheet if no default has been specified. The next text box shows the If instruction that conditions the execution of the statement. If the condition is evaluated as False, the SQL text box will to show FALSE instead of the SQL statement to be executed. The last two list boxes, show the Bind and Extend lists. After the reference or name, the lists displayed the Excel Al notation for the column bound or extended (between the parenthesis).

In short, the invention actually retrieves, for each section and row, the current value from on Excel Sheet and replaces the correspondent field in the SQL statement. The debug tool provides the user with confidence regardless of the statement he executes against the ODBC driver.

Using the Invention for Visual Basic

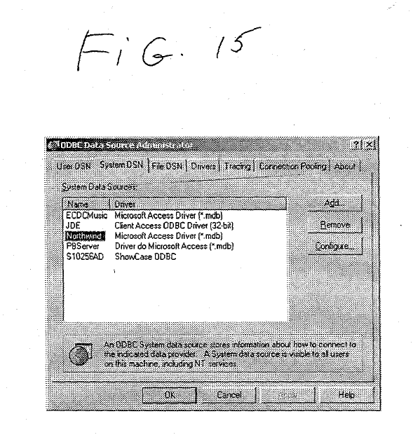

As shown in FIGS. 14a and 14b, the present invention facilitates the automation of massive operations using the present invention by VB code.

Sample Applications

These examples use two different ODBC sources. Customer Management uses a Microsoft Access database called Northwind shipped as a sample with Microsoft Office. Expense Report and Items Master use a DB2/400 database for J. D. Edwards.

Customer Management

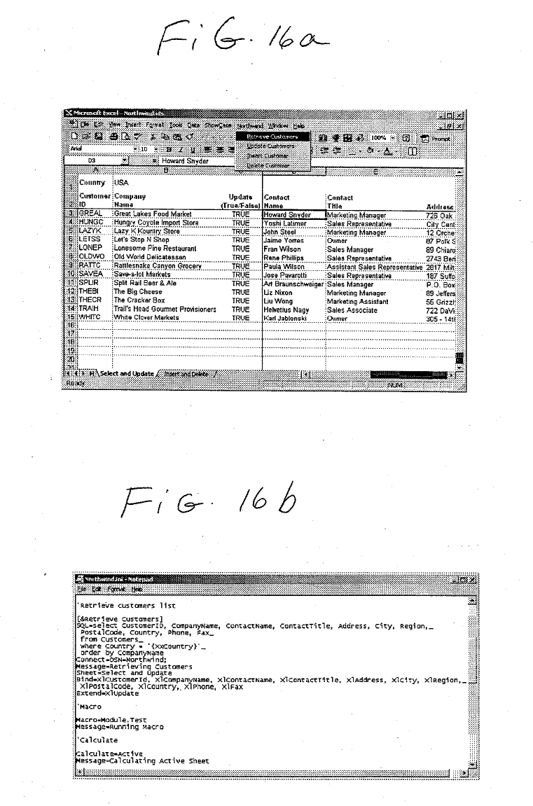

Referring to FIG. 15, the following example sets forth a complete customer management application. Initially, the user should verify the Data Source Administrator, and that he has defined an ODBC data source for the access database Northwind.mdb. It is critical to define a new data source following the procedure explained in the chapter Getting Started. The user opens the sample Customer Management workbook (Northwind.xls) in the Samples folder. The add-in ODBCFace.xla is opened automatically and the splash screen of the application is displayed for a couple of seconds. The application will then add to the Excel Menu bar menu from Northwind.

Retrieve Customers

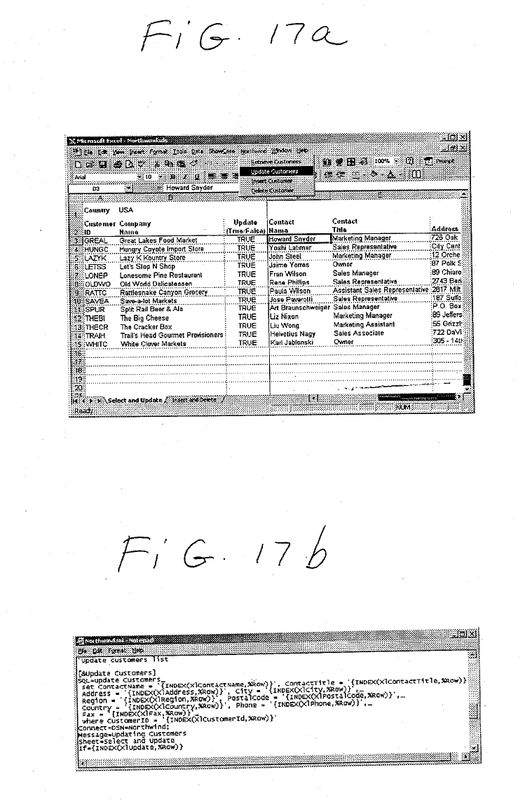

Referring to FIGS. 16a and 16b, the Retrieve Customers Command retrieves the list of customers available for the country specified in the tab Select and Update. The following is the definition of the Retrieve Customers Command. The binding list respects the Order of the retrieved columns. The Extend instruction takes care of extending the column Update and its initial value (TRUE). It is to be appreciated that after retrieving the customers'information, a script runs a simple Macro included in the sample (it simply displays a message box) and recalculates the active sheet.

Retrieve Customer List

[& Retrieve Customers]

SQL-select CustomerID, CompanyName, ContactName, ContactTitle, Address, City, Region,_{—}

PostalCode, Country, Phone, Fax_{—}

From Customers_{—}

Where Country={XXCountry}_{—}

Order by CompanyName

Connect=DSN=Northwind;

Message=Retrieving Customers

Sheet=Select and Update

Bind=X]CustomerID, X]CompanyName, X]ContactName, X]ContactTitle, X]Address, X]City, X]Region,_{—}

X]PostalCode, X]Country, X]Phone, X]Fax_{—}

Extend=X]Update

Macro

Macro=Module, Test

Message=Running Macro

Calculate

Calculate=Active

Message=Calculating Active Sheet

Update Customers

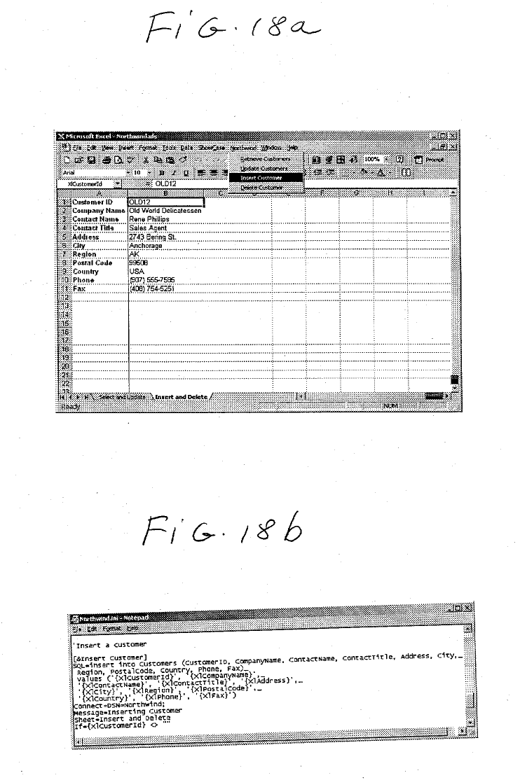

As shown in FIGS. 17a and 17b, the Update Customers Command updates the customers in the database with the values specified in the tab Select and Update tab. The following defies the definition of the Update Customers Command. It is to be noted that every field is now specified as recurring (i.e. ‘{INDEX(XIContactName, % Row)}’). The If key specifies the interface to update only those customers with a value of TRUE in the column Update. In this manner, it is possible to selectively update only certain records in the database.

Update Customer List

[& Update Customers]

SQL=Update Customers_{—}

Set ContactName={INDEX(X]ContactName, % ROW)}, ContactTitle={INDEX(X]ContactTitle, % ROW)}

Address={INDEX(X]Address, % ROW)}, City={INDEX(X]City, % ROW)}

Region={INDEX(X]Region, % ROW)}, PostalCode={INDEX(X]PostalCode, % ROW)}

Country={INDEX(X]Country, % ROW)}, Phone {INDEX(X]Phone, % ROW)}

Fax={INDEX(X]Fax, % ROW)}

Where CustomerID={INDEX(X]CustomerID, % ROW)}

Connect=DSN=Northwind;

Message=Updating Customers

Sheet=Select and Update

If={INDEX(X]Update, % ROW)}

Insert Customer

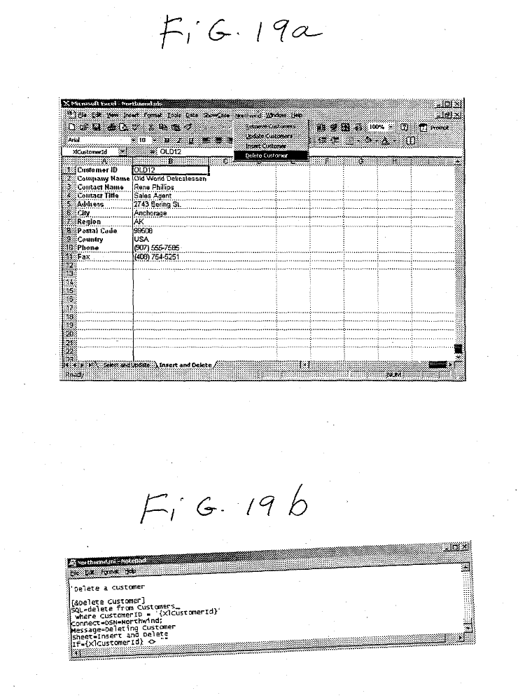

Referring to FIGS. 18a and 18b, the Insert Customer Command adds a new customer in the database with the values specified in the tab Insert and Delete. The following defines the Insert Customer Command. It is noted that this time every field is defined as single cell (i.e. ‘{XICustomerId}’).

Insert a customer is defined below:

[& Insert Customer]

SQL=insert into customers (CustomerID, CompanyName, ContactName, ContactTitle, Address, City, Region, PostalCode, Country, Phone, Fax)_{—}

Values (“{X]CustomerID }’, (“{X]CompanyName}’, (“{X]ContactName}’, (“{X]ContactTitle}’, (“{X]Address }’, (“{X]City }’, (“{X]Region}’, (“{X]PostalCode }’, (“{X]Country }’, (“{X]Phone}’, (“{X]Fax}’)

Connect=DSN=Northwind;

Message=Inserting Customers

Sheet=Insert and Delete

If=(“{X]CustomerID}<>“”

Delete Customer

Referring to FIGS. 19a and 19b, the Delete Customer Command removes the customer specified in the tab Insert and Delete from the database. The following is the definition of the Delete Customer Command. Notice how the If key verifies that a customer has been selected before attempting to delete it.

Delete a Customer

[&Delete Customer]

SQL=delete from Customers_{—}

Where CustomerID=”{X]CustomerID}

Connect=DSN=Northwind;

Message=Deleting Customers

Sheet=Insert and Delete

If={X]CustomerID}<>“”

Expense Report

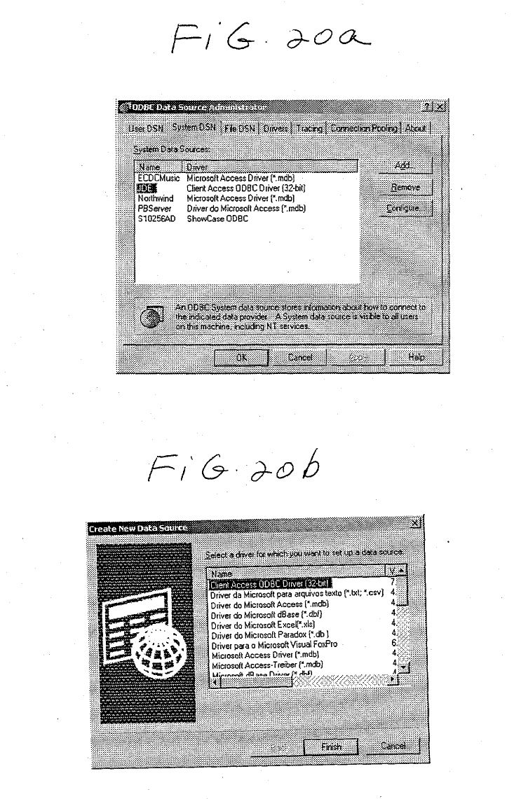

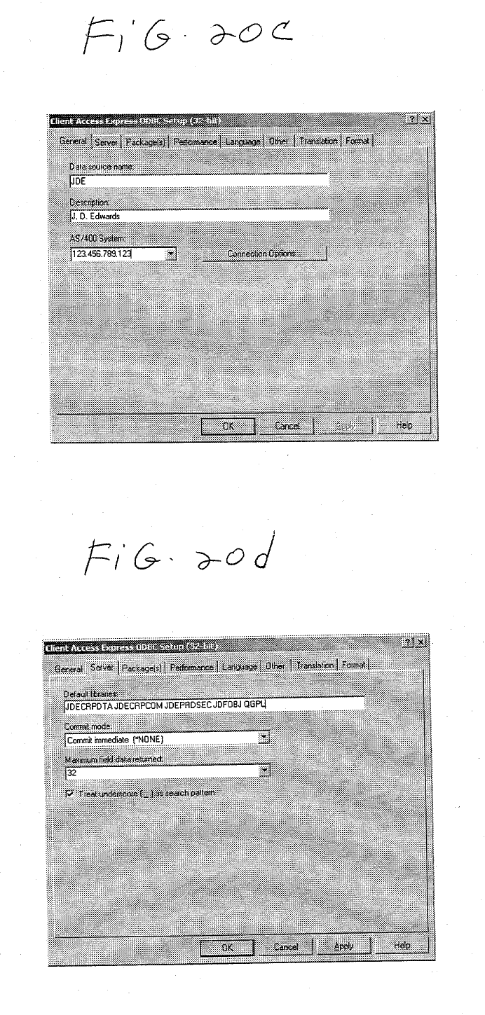

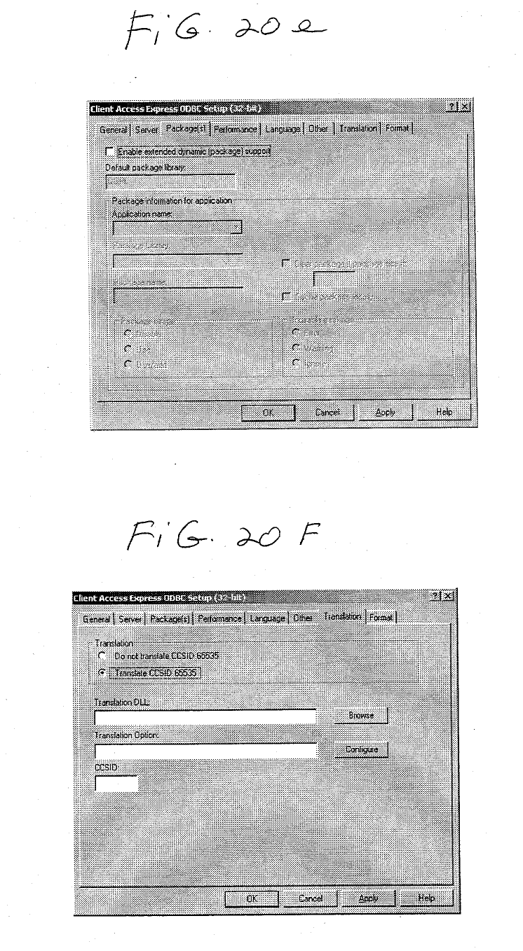

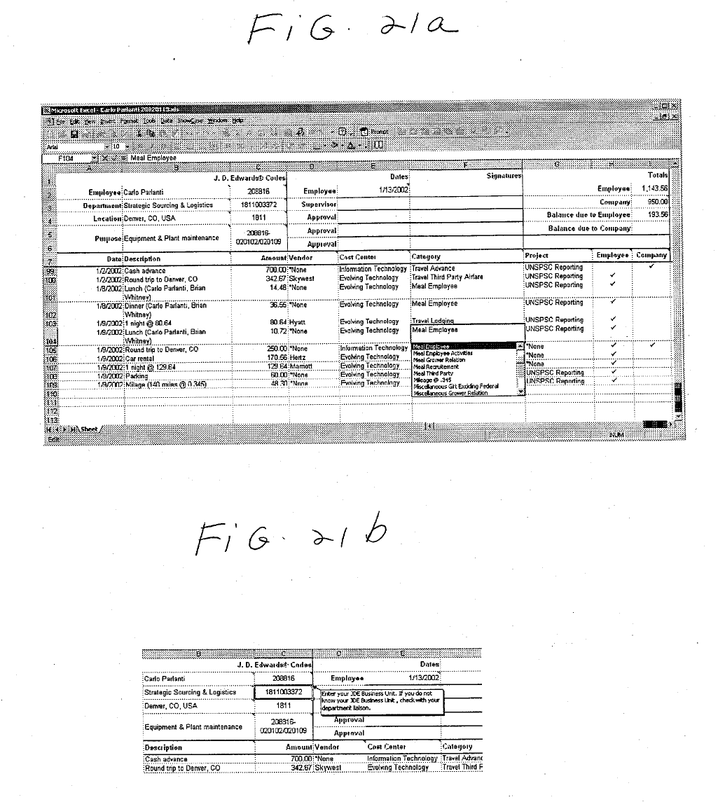

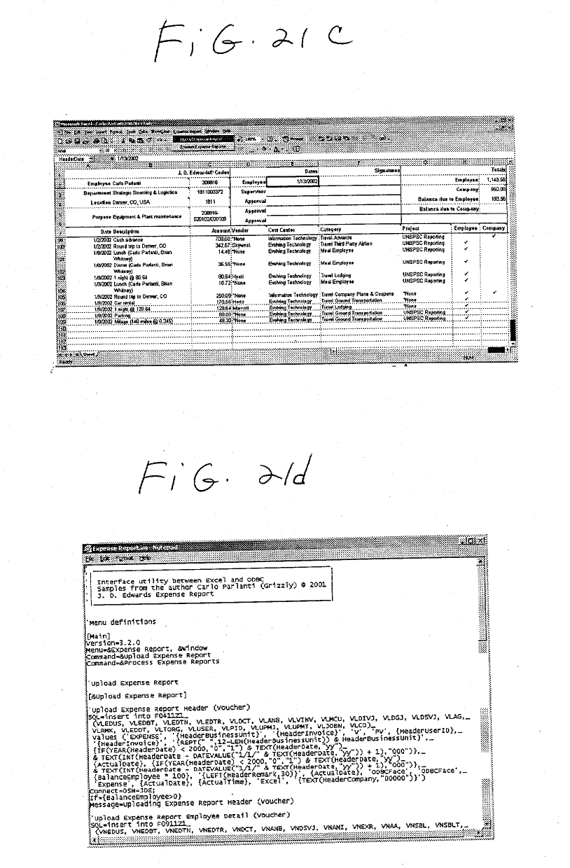

Referring to FIGS. 20a to 20f, the present invention is now described in the context of a further example including an Expense Report. The Expense Report provides an automated interface to upload expense reports to J. D. Edwards® Accounts Payable using the A/P and A/R Batch Upload process. In order to test this sample, it is necessary to define an ODBC data source for the J. D. Edwards® DB2//400 database. Run the ODBC Data Source Administrator, click on the System DSN tab and again on the button Add to add a new Client Access data source. When prompted, the user will access Client Access ODBC Driver (32-bit) section and click on the button Finish.

The user assigns the name JDE in the text box Data Source Name and the description J. D. Edwards® in the text box Description. The drop down list for the AS/400 System is then clicked and appropriate AS/400 is selected. The tab Server is clicked on and name of the data library, is entered followed by a blank space, the name of the user's common library followed by a blank space, the name of the user's security library followed by a blank space, the name of the user's object library is entered followed by a blank space and finally the name of the IBM® general-purpose library QGPL.

It may be desirable to use the Conference Room Pilot or test libraries as a test instead of production libraries. First, the user will click on the tab Package(s) and disable the extended dynamic (package) support, then the user should click on the tab Translation and select Translate CCSID 65546 (the J. D. Edwards® database supports double byte character sets). The user clicks OK to confirm his choices and OK again to close the ODBC Data Source Administrator. The user is now ready to try the expense report sample interface. The user will browse, using Windows Explorer, to the folder C:\Program Files \ODBCFace\Samples and double click on the Excel workbook Carlo Parlanti 20020113.xls. Excel will open the sample expense report for the J. D. Edwards® database. The user will browse, using Windows Explorer, to the folder C:\Program Files\ODBCFace and double click on the Excel add-in ODBCFace.xla. The ODBCFace interface add-in is going to be loaded and you are going to briefly see the splash screen of the application. ODBCFace will add to the Excel Menu bar the Menu Expense Report.

Upload Expense Report

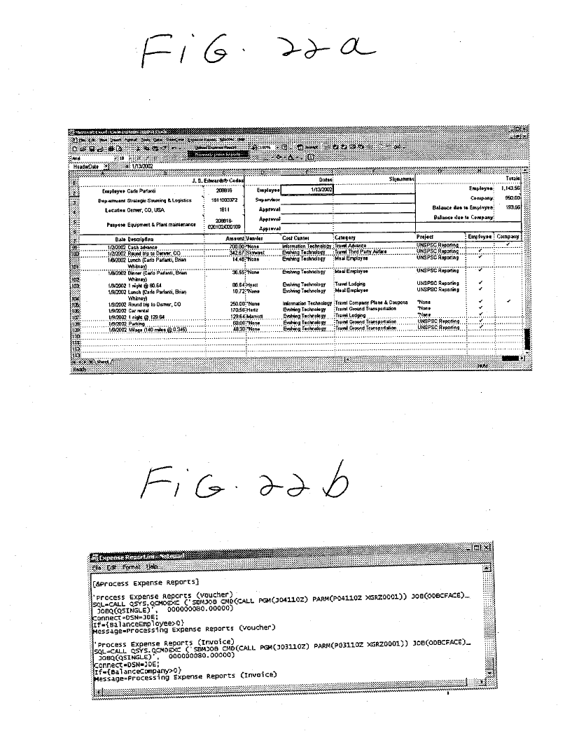

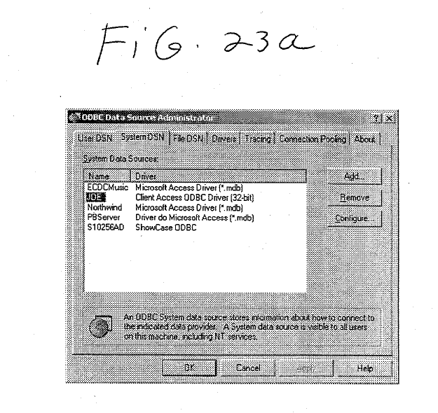

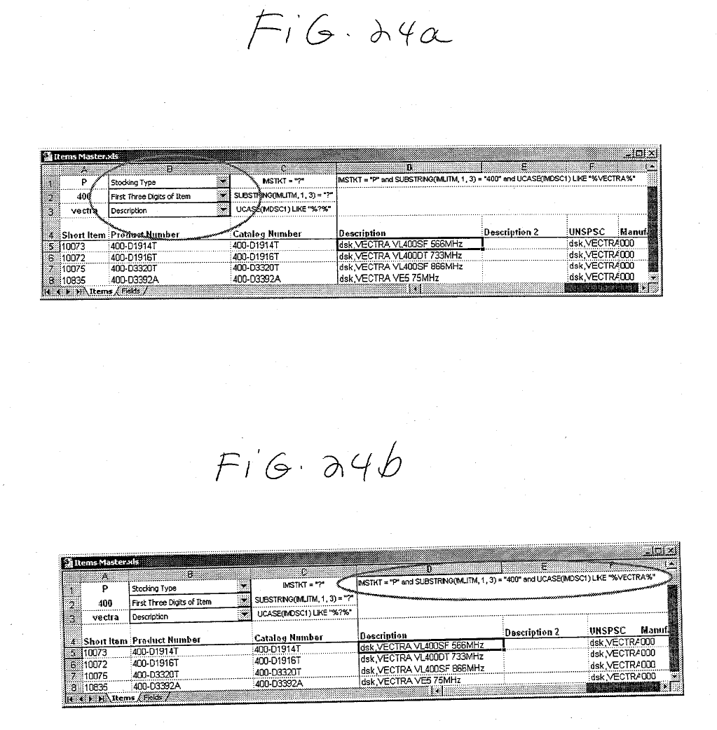

Referring to FIGS. 21a to 21d, this example is an automated expense report with online prompting for cost centers, expense categories, special projects or subledgers, and vendors (hidden in rows 9 through 99). The user can unprotect the Sheet by using Tool, Protection, Unprotect Sheet if you want to examine these lists and the formulas that are referring to the external cheat sheet Expense Cheat.xls. By placing the cursor in the cost center, expense category, special project or vendor columns, and clicking the right button of the mouse, the user will be able to choose the Command Pick From List. Excel will prompt the user with a list of the possible values that you can use in that field. The user can also simply place the cursor in the cell, press F2 to enter the edit mode and press the shortcut Alt+down arrow to display the pick list. The workbook contains numerous comments to explain the meaning of the different fields in the model. This is an example of an expense report already filled in (wouldn't that be nice . . . ) but the folder Samples also contains an empty template (Expense Report.xlt) that can be copied to the Office templates folder (to use it just choose File, New from the Excel Menu bar).

The Upload Expense Report Command uploads the expense report to the J. D. Edwards® A/P and A/R batch upload files F0411Z1, F0311Z1 and F0911Z1. The header information is uploaded into F0411Z1 or F0311Z1 and the detailed information are uploaded into F0911Z1 representing the G/L distribution for the expense report. The following is the definition of the Upload Expense Report Command. Notice that the Upload Expense Report section is running SQL statements one after the other. The first and fourth statements are non-recursive and load the expense report itself. The second, third, fifth and sixth statements are recursive and load the G/L distribution. It is noted that, since they are all working on the same data source, the connection string is not repeated after the first section. If the user uses the Batch Voucher or Invoice Review functions in J. D. Edwards® he will be able to look-up his batch expense report after uploading it.

Process Expense Reports

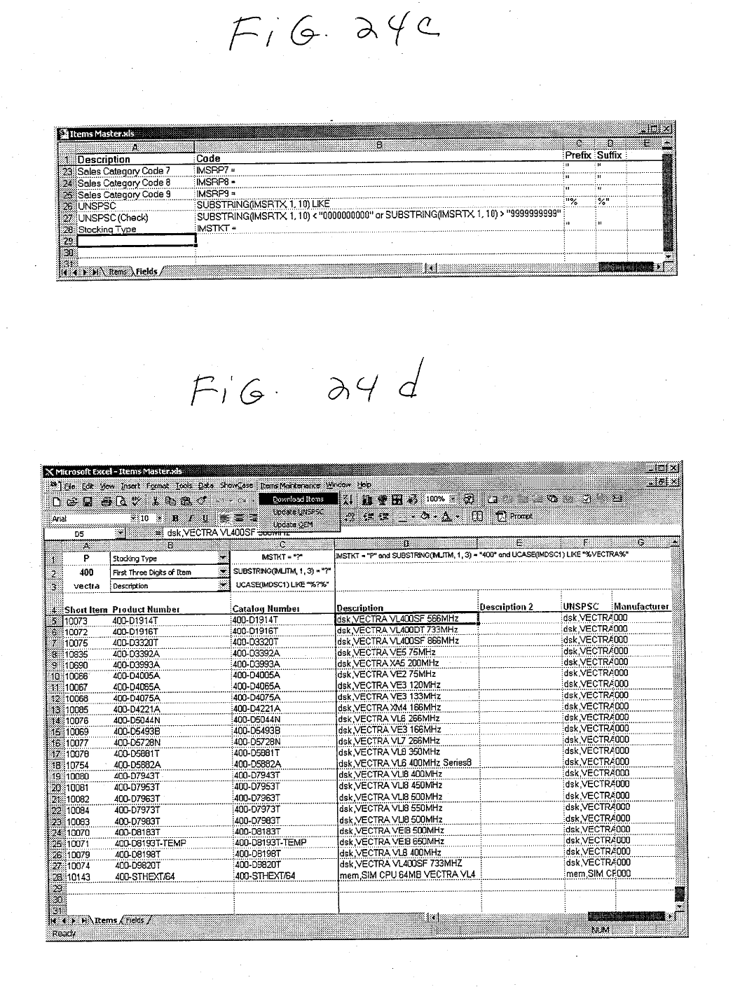

As shown in FIG. 22a-22b, the Process Expense Reports Command submits the Batch Voucher or Invoice Processing program in the J. D. Edwards® system as shown. The following is the definition of the Process Expense Reports Command. Note that the Command is using a special extension of IBM® DB2/400 ODBC driver that gives the capability to submit a host job using the syntax CALL and the system program QCMDEXC (system Command execution). It is noted that the possibility to specify the version of the batch job to be executed: XGRZ0001. It may take some time to correct the information in the expense report to match valid codes in your system and to prepare a version of the Batch Voucher or Invoice Processing program to complete the test. After doing that, the user should be able to process a batch directly from Excel and end up with a valid voucher in Accounts Payable or Invoice in Accounts Receivable.

Items Master

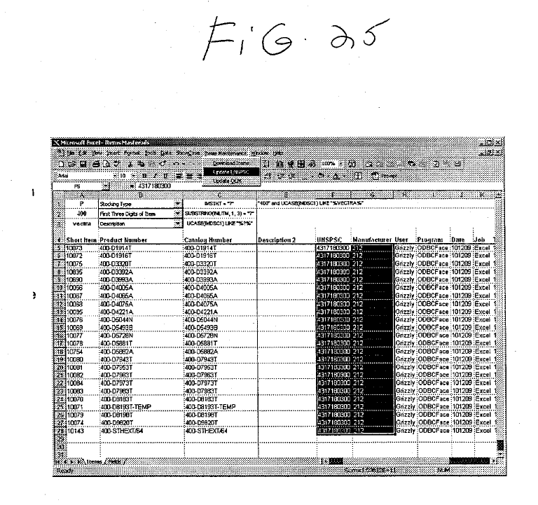

Referring to FIG. 23a, Items Master is an automated interface to maintain items in the J. D. Edwards® Inventory. In order to test this sample, the user will need to define an ODBC data source for the J. D. Edwards® DB2/400 database. The user will verify, using the ODBC Data Source Administrator, that the user has defined an ODBC data source for the DB2/400 J. D. Edwards® database. If not, the user will need to define a new data source following the procedure explained above regarding Expense Reports. Browsing, using the Windows Explorer, to the folder C:\Program Files\ODBCFace\Samples and the user will double click on the Excel workbook Items Master.xls. Excel will open the sample Items Maintenance for the J. D. Edwards® database. Immediately after opening the workbook, the interface add-in will be loaded and the user will briefly see the splash screen of the application. The reference will be added to the Excel Menu bar the Menu Items Maintenance.

Download Items

As shown in FIGS. 24a to 24d, the workbook is an automated item maintenance tool with dynamic selection of items. Three drop-down boxes on the top left corner give the user the ability to select items using virtually any combination of selection criteria. After entering selection values in the first three cells of column $A:$A, the workbook uses the tab fields and certain formulas to convert the criteria into a WHERE string for the SQL statement. If you want to add additional selection criteria you can click on the tab Fields and add them. After entering the selection criteria and values, the user can click on the Command Download Items in the Menu Items Maintenance to perform the extraction.

Update UNSPSC or OEM

Referring to FIG. 25, after downloading the items, it is then possible for the user to assign them an UNSPSC class (this is written in the field Search Text) and a manufacturer code (is going to be written in the first Purchasing Category Code). By choosing the Command Update UNSPSC (or Update OEM) from the Menu Items Maintenance, the user can update the Items directly in the J. D. Edwards® Inventory module.

Other Samples

The present invention suggests a multiple interface using the invention to help users with production activities and Conference Room Pilot implementations. Budgets and estimates can be uploaded, converted and classified from one system to another.

Excel Names

It is recommended that the user use names within Excel instead of pure references ($A:$A). Formulas are easier to read and the maintenance of the workbook and of the profile file is facilitated. The samples provided with this interface will give you a good idea how to use Names instead of references in an Excel workbook.

Totals Below Downloads

The invention preserves the content of a Sheet below the data as it is being downloaded from the ODBC data source. After retrieving the data, the invention compares the current extent of your data list with the record set retrieved and decides to extend or reduce the binded and extended columns accordingly. It performs this by inserting additional rows, pushing further down any preexisting data below, or deleting extra rows, pulling up the data below.

The extent to which the data needs to be extended or reduced is evaluated by looking up the first empty cell in the reference column defined in the invention Setup window. The user should leave one row of extra space below the listing and before the totals or any other information (the user can eventually hide the row for esthetical reasons). The reason for this precaution is that, in case a query is going to retrieve one single record or no records at all, the formula is still going to refer to an array of two cells. This way, after refreshing the list with some new criteria, the invention will be able to insert additional space between the two surviving rows preserving the integrity of your formula.

ODBC Drivers

It is strongly suggested that that vendor install the latest patch on the ODBC driver. Too often the initial release of terminal emulation or communication packages lacks in functionality. It is desired to share ODBC data sources with others to create a file DSN instead of a systems or user DSN. Simply click on the tab File DSN and add the data source definition. By default the file DSN is going to be created in the folder C:\Program Files\Common Files\ODBC\Data Sources but you can browse to a directory on your network and use the button Set Directory to change this default.

Changing Environments

One of the features of the invention is that it is capable of being used working in different environments (Production, CRP, Test, etc.) It is possible to create a DSN without specifying a library list and prefix each file with a library name retrieved from the Excel model. This may be particularly useful when the user plans to use the invention models to migrate information between environments. The invention also makes it possible to improve the Excel model and provide the user with a drop-down box instead of asking him to type the library name in a cell.

IBM® Sample ODBC Security Exit Program

The security aspect of an ERP (Enterprise Resources Planning) implementation may generally be a big concern. With packages like J. D. Edwards®, it is not uncommon to authorize every user to access any operation on the database tables and delegate the security aspect to ERP package itself. Introducing client server and ODBC techniques in such an environment represents a serious security exposure that needs to be addressed.

In an AS/400 based implementation of the J. D. Edwards® system, you can, fortunately, take advantage of the enhanced IBM® security to protect yourself from unauthorized accesses to the database. IBM® provides a multitude of operative system exit points that you can use to develop your own security programs to manage client server and ODBC access. The user can manage these exit points using the command WRKREGINF in OS/400. In the folder IBM Library Reader Extract the user can use an extract from the manual AS400 Client Access for Windows ODBC User's Guide (you can request the full AS/400 softcopy library directly from IBM). This extract contains an ILE C/400 sample exit program and the multiple exit program parameters that can be used in a client server environment. If the organization lacks in ILE C/400 skills, or simply prefers to avoid in house development, there are many commercial packages available to help address these security concerns.

Microsoft® Components Installation

The invention uses two Microsoft® components: Common Dialog Control 6.0 SP3 and Data Access Components MDAC 2.5 SP2. If the system is missing one of these components Excel is going to display one or more error messages when you try to open ODBCFace. To help you install these components we have provided two sub-folders called Microsoft Common Dialog Control 6.0 SP3 and Microsoft Data Access Components MDAC 2.5 SP2 in the folder ODBCFace. The first folder contains a batch (Install.bat) that you can run to install the components required for the common dialog window to run. If the components are already installed the program is not going to replace them.

Otherwise a command prompt will confirm the copy of the needed file and, immediately after, a window to confirm the registration of the component. The second folder contains the Microsoft® installation program for the Data Access Components (MDAC_typ.exe). You can follow the instructions to install MDAC (keep in mind that it may ask you to reboot your machine). If the Data Access Components (MDAC 2.5 SP2) are already installed on your system, the installation program will prevent the user from reinstalling them.

The present invention has been described in context of the preferred embodiment. The true nature of the present invention is to be determined with reference to the claims.

1. A generalized system between a first user system and any universal data access provider or open database connectivity data source for database management systems comprising:
means for affixing to a first program instructions from a generalized interface between a first application and any UDA (Universal Data Access) provider or ODBC (Open Database Connectivity) data source for a DBMS (Database Management Systems);
means to affix instructions on the first application such that a sequence of statements to be performed for each Command can be sent to the DBMS via UDA.

2. The system of claim 1 wherein the first program is Microsoft Excel and the DBMS is DB2/400.

3. A method for operating a generalized interface between an Electronic Spreadsheet such as Microsoft Excel and an UDA data provider or ODBC data source for a DBMS comprising the following steps:
retrieving a value from a first end user application having a graphical interface field and replacing the corresponding field in the first application with at least one command or comment relevant to a DBMS statement; and affixing the command or comment inside said DBMS statement and storing said command or comment within a database associated with said DBMS.

4. A generalized system between a first user system comprising a workbook and any universal data access data provider or open database connectivity data source for database management systems comprising:
means for affixing to the interface of first workbook program instructions from a generalized interface between said first application and any UDA (Universal Data Access) data provider or ODBC (Open Database Connectivity) data source for a DBMS (Database Management Systems); and
means to embed commands from said first workbook application via the DBMS into the database.

5. The system of claim 4 wherein the first program is Microsoft Excel and the DBMS is DB2/400.

6. A novel interface between a first workbook application having a menu interface and any UDA data provider or ODBC data source wherein said interface reads a script and enables a user to add commands to the menu interface of the workbook application.
